(19) United States
(12) Patent Application Publication
(10) Pub. No.: US 2018/0195644 A1
(43) Pub. Date: Jul. 12, 2018

(54) SUPPORT DEVICE FOR AT LEAST ONE PORTION OF A LINEAR STRUCTURE FOR CROSSING AN UNEVEN UNDERWATER TOPOGRAPHY, ASSEMBLY COMPRISING SAID DEVICE AND METHOD OF SUPPORT

(71) Applicant: SAIPEM S.P.A., San Donato Milanese, Milano (IT)

(72) Inventors: Furio MARCHESANI, San Donato Milanese (IT); Roberto BRUSCHI, San Donato Milanese (IT); Adelina MANCINI, San Donato Milanese (IT); Luigino VITALI, San Donato Milanese (IT)

(21) Appl. No.: 15/743,947

(22) PCT Filed: Jul. 15, 2016
(86) PCT No.: PCT/IB2016/054232

§ 371 Date: Jan. 11, 2018

(30) Foreign Application Priority Data
Jul. 15, 2015 (IT) 102015000034346

(51) Int. Cl. F16L 1/24; F16L 1/20; H02G 1/10; E01D 15/24

(52) U.S. Cl. CPC F16L 1/24; E01D 15/24; H02G 1/10; F16L 1/201

(57) ABSTRACT

A resting device (1) of at least one portion of a linear structure (2) is for crossing an uneven underwater topography. The resting device (1) is suitable for supporting at least one portion of the linear structure (2) that defines a longitudinal direction (X-X) coincident with or parallel to the longitudinal development direction of the linear structure (2). The resting device (1) includes at least one buoyant element (3) and at least one tether (4), suitable for constraining the resting device (1) to a bed (5). The at least one buoyant element (3) is suitable for providing a sufficient buoyancy to keep the at least one tether (4) under tension. A deck (6) has a shape and material that allows distributed resting of at least one portion of the linear structure (2) on the resting device (1).

### FIELD OF THE INVENTION

The object of the present invention is a resting device of at least one portion of a linear structure for crossing an uneven underwater topography, as well as an assembly comprising said resting device, as well as a resting method.

In particular, the present invention refers to an underwater resting device.

Said linear structure is an underwater linear structure. The term “linear structure” is meant to indicate a structure the extends primarily along a longitudinal direction and is for example a section of a continuous pipeline for transporting fluid, like for example gas and/or petroleum and/or other hydrocarbons, or a section of a pipeline for transporting water, or a section of an electric cable suitable for transporting energy or information. Said linear structure can comprise joining elements suitable for connecting adjacent pieces of linear structure. Said linear structure is suitable for providing a transiting flow inside it, and said flow is for example a flow of a liquid or gaseous fluid. Said uneven underwater topography is a portion of a bed, or of a salt water lake bed, or of a lake bed, or of a pond bed or of a river bed, characterized by the presence of depressions, channels, excessive depths, escarpments and/or canyons, or characterized by portions of unstable or yielding earth, which make the laying of the underwater linear structure substantially unsuitable. Said bed can also comprise a knee, i.e. an area characterized by a sudden change in slope.

### STATE OF THE ART

Solutions of underwater linear structures are generally known that foresee the use of buoys that cooperate with tie rods anchored to the bed in order to counteract the upward thrust of said buoys.

For example, document U.S. Pat. No. 3,738,112A describes a system for anchoring to the bed “with reverse suspended bridge”, wherein a series of tie rods of different length connects the floating linear structure to a flexible cable constrained to the bed in its ends, and wherein said cable in operating conditions takes on the characteristic catenary form, typical of suspended bridges.

Document U.S. Pat. No. 7,963,721B2 shows a solution that uses distributed floats that cooperate with flexible joints rested on the bed to modify the curvature of a portion of linear structure so as to allow depressions and escarpments of the bed to be passed.

U.S. Pat. No. 6,655,641B2 shows a solution of a suspended system for supporting a rigid linear structure, wherein floating elements distributed along the length of said rigid linear structure push said structure upwards and wherein the tie rods allow anchoring to the bed; alternatively, if said rigid linear structure is to be suspended outside of the water, said suspended system is a taut cable above the rigid linear structure from which the structure is hung through a series of hooks.

Moreover, documents KR20100120326A, WO2009/039605A1 and U.S. Pat. No. 3,849,821A show some examples of submerged underwater tunnels for means of transport to pass through, wherein the provision of floating elements gives floating properties to the tunnel itself and wherein a series of tie rods distributed along the length of the tunnel anchor it to the bed.

The solutions described above, although partially advantageous, do not solve many drawbacks. Indeed, the use of floats and anchors directly applied to the linear structure, in the attempt to avoid the linear structure having to follow the depressions of an uneven underwater topography, or in the attempt to suspend the linear structure above a canyon or a yielding bed, generates thrusts and/or localized forces that cause an increase in the tensions and stresses on relatively small portions of the linear structure.

Moreover, the use of said known systems, forces the suspended section of a linear structure to take up a geometry that promotes the occurrence of tension spikes and of localized deformations. Indeed, when the entire weight of the linear structure and of the flow crossing it is suspended from a series of floats connected to it, to keep the linear structure suspended said floats need to be sized precisely and in the case of an unforeseen event, for example at least one may become disconnected, they can deform the linear structure and lead to a further increase in localized tensions on a portion of said linear structure. Moreover, an underwater linear structure is also subjected to environmental stresses, such as underwater currents and turbulent motion of the mass of water in which it is submerged, or to marine weather forcers, which impose stresses mainly on the linear structure.

The anchoring tie rods are also subjected to a variety of forces, for example forces generated by underwater currents, or to marine weather forcers, acting on the linear structure, as well as to the forces that derive from the upward thrust of the associated floats.

Further increases in tensions and localized stresses can occur during the laying and installation step of the linear structure.

Localized increases in tension and stress, particularly if for a prolonged period of time, or if they are repeated cyclically in operative conditions, can end up compromising the integrity of the linear structure.

Moreover, document US20060159523A1 shows a framework comprising floats suitable for constraining to discrete portions of a linear structure. Further solutions that show floating underwater supports anchored to the bed suitable for forming a precise support are shown, for example, by documents US2006062635A1, US2011286802A1, U.S. Pat. No. 5,505,560A and WO2014184480A1. Such solutions impose that the linear structure is small in size and highly flexible. Moreover, the floats used in these known solutions are much larger than the linear structure, making the supports unsuitable for supporting a large linear structure, since in that case the hydrostatic thrust provided by the floats would be enormous and such as to de-anchor the support from the bed. Therefore, there is a need to prevent said underwater linear structure from being subjected to a great height difference and at the same time to prevent said linear structure being subjected to localized thrusts. In particular, there is a great need to avoid localized stress or overstress on the linear structure, for example caused by a geometric arrangement of the structure itself that causes a localized bending, as well as at the same time a localized stress given by an anchored float element or a tie rod, for anchoring to the sea bed.

At the same time, there is a need to provide a support for a rigid and heavy linear structure, allowing them to cover vast uneven underwater topographies, without for this reason forming stress peaks.

### Solution

A purpose of the present invention is to avoid the drawbacks of the prior art and to provide a solution to the requirement of providing a device suitable for allowing distributed resting of at least one portion of a linear structure.

A further particular purpose of the present invention is to provide a solution to the requirement of providing a device suitable for giving a geometry that is as horizontal as possible to a section of linear structure also at a height difference of the bed.

This and other purposes are accomplished with a resting device according to claim 1, as well as an assembly comprising said resting device according to claim 6, as well as a resting method according to claim 9.

Thanks to the provision of a resting device according to the invention having floating properties and anchored to the bed, it is possible to ensure that said at least one portion of a linear structure is rested in a distributed manner, limiting the deformations of said structure as well as the size of stresses acting on at least said portion of linear structure.

Some advantageous embodiments are the object of the dependent claims.

### FIGURES

Further characteristics and advantages of the device, of the assembly and of the method will become clearer from the following description of preferred embodiments thereof, given for indicating and not limiting purposes, with reference to the attached figures, in which:

FIGS. 1A and 1B are schematized illustrations showing a device for launching, or laying, a linear structure suitable for applications in medium depth bodies of water and in deep bodies of water;

FIG. 2A is a perspective view illustrating a part of a resting device according to an embodiment of the invention;

FIG. 2B illustrates a diagram of the forces acting on a schematized section of an assembly according to an embodiment of the invention;

FIGS. 2C and 2D are schematized section views showing two embodiments of a device according to the invention;

FIG. 3 is a schematized view from above of a device according to an embodiment of the invention;

FIGS. 4A and 4B are axonometric views illustrating a part of a device according to an embodiment of the invention;

FIG. 5 is a schematized vertical top side view illustrating a device in accordance with an embodiment of the invention;

FIG. 6A is a schematized vertical top side view showing a step of a resting method according to a possible way of operating;

FIGS. 6B-6D and 7A-7C are schematized vertical top side views illustrating some embodiments of an assembly according to the invention;

FIGS. 8A-8F illustrate some mounting steps of a device in accordance with an embodiment of the invention;

FIGS. 9A-9E show the analysis of the static tension acting on the linear structure during some steps of a possible method according to a possible way of operating (the static tension values are normalized).

### DESCRIPTION OF SOME PREFERRED EMBODIMENTS

In accordance with a general embodiment, a resting device 1 of at least one portion of a linear structure 2 for crossing an uneven underwater topography is provided. Said resting device 1 is suitable for supporting at least one portion of said linear structure 2 that defines a longitudinal direction X-X coincident with or parallel to the longitudinal development direction of said linear structure 2. Said resting device 1 also comprises at least one buoyant element 3 and at least one tie rod 4, suitable for constraining said resting device 1 to a bed 5.

In accordance with an embodiment, said linear structure 2 is substantially rigid against flexing. In accordance with an embodiment, said linear structure 2 is for example a section of a continuous pipeline for transporting fluid, like for example gas and/or petroleum and/or other hydrocarbons. In accordance with an embodiment, said uneven underwater topography can extend for hundreds of meters or for a few kilometers.

Said at least one buoyant element 3 is suitable for providing sufficient buoyancy to keep said at least one tie rod 4 under tension.

Said resting device 1 also comprises a deck 6 having a shape and material that allows distributed resting of at least one portion of said linear structure 2 on said resting device 1.

In accordance with an embodiment, the term “distributed resting” is meant to indicate that even if the resting of the linear structure on the deck takes place in distinct and separate portions, overall said linear structure rests on said deck in a distributed manner, avoiding jamming or localized bending, and it is not meant to indicate that said deck provides a support for the linear structure without interruptions in the longitudinal direction X-X.

In accordance with an embodiment, said resting device 1 is a rigid bridge. In other words, said resting device 1 avoids comprising joints or articulations suitable for allowing the relative movement of portions of said deck 6.

In accordance with an embodiment, said deck 6 has a longitudinal extension comprised between 25 meters and 100 meters, and more preferably comprised between 35 meters and 75 meters, and more preferably about 50 meters. In accordance with an embodiment, a longitudinal deck direction Y-Y is defined, substantially coincident with the longitudinal development direction of said deck 6. In accordance with an embodiment, said longitudinal deck direction Y-Y is coincident with or parallel to the longitudinal direction X-X of said linear structure 2.

Advantageously, said deck 6 can be designed and made to give said at least one rested portion of said linear structure 2 an optimized shape, suitable for minimizing the size of the localized tensions and forces acting on said linear structure 2, as well as suitable for minimizing phenomena of structural instability (buckling) along the longitudinal direction X-X, as well as suitable for preventing localized bends from forming on said linear structure 2.

Advantageously, the provision of a resting device 1 that allows distributed resting for at least one portion of said linear structure 2, makes it possible to influence the vibration frequency of at least one suspended portion of said linear structure 2, both in value and in shape, for example modifying the characteristics of rigidity and damping, so as to make it suitable for avoiding instability and/or resonance caused by underwater currents or by marine weather forcers.

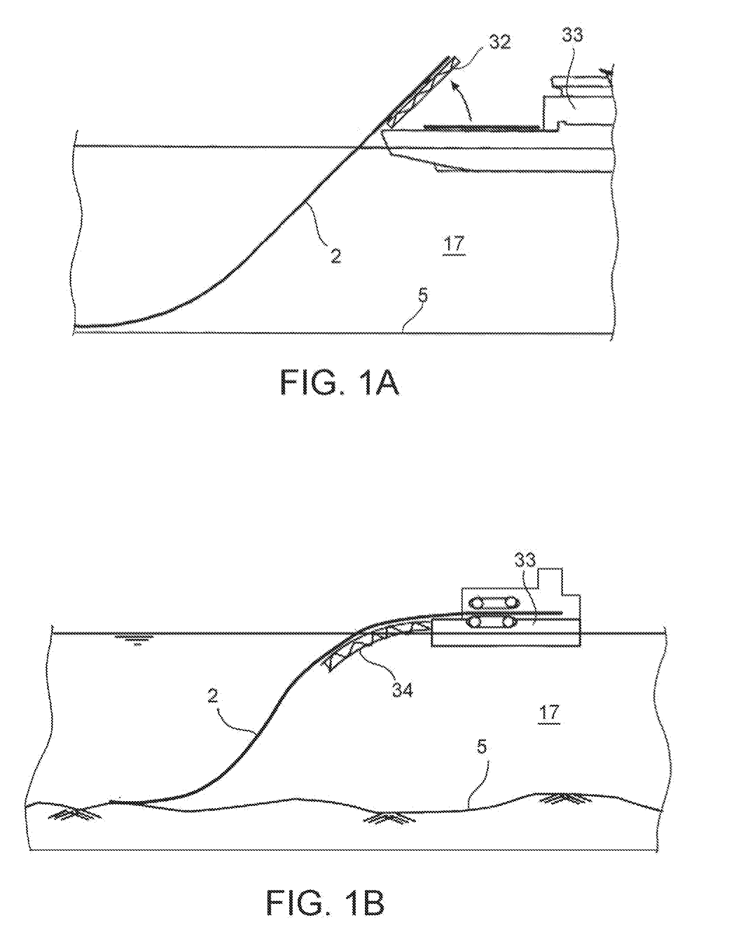

As illustrated in FIGS. 1A and 1B, said linear structure 2 can be laid on a medium or deep bed and/or on a resting device 1 through the use of a laying device 33.

In accordance with an embodiment, said resting device 1 is made in the form of an inverted cable-stayed bridge, anchored to the bed 5 and thrusting on at least one portion of said linear structure 2.

In accordance with an embodiment, said deck 6 describes a height difference at least along the longitudinal direction X-X suitable for allowing distributed rest of at least one portion of said linear structure 2.

In accordance with an embodiment, said deck 6 describes a substantial arc shape along the longitudinal direction X-X.

The provision of a substantial arc shape of said deck 6 of said resting device 1 along the longitudinal direction X-X makes it possible to optimize the resting of at least one portion of said linear structure 2, for example providing a radius of curvature suitable for supporting said linear structure 2 rested in a distributed manner on said deck 6, when in operative conditions, avoiding the formation of localized bends and/or stress peaks.

In accordance with an embodiment, said at least one tie rod 4 is anchored to, or rested on, said bed 5 through anchoring elements 13.

In accordance with an embodiment, said device comprises at least one further tie rod 4, so as to comprise at least two tie rods 4, and wherein said at least two tie rods 4 are anchored or rested on said bed 5 by means of anchoring means 13, and wherein said at least two tie rods 4 are constrained to said resting device 1, in the shoulder portions 19 thereof.

In accordance with an embodiment, said device comprises three further tie rods 4, so as to comprise four tie rods 4, and wherein said four tie rods 4 are anchored or rested on said bed 5 through anchoring elements 13, and wherein said four tie rods 4 are constrained close to four corner portions 29 to said resting device 1.

In accordance with an embodiment, said four tie rods 4 are sized so as to evenly spread the upward thrust provided by said at least one buoyant element 3 of said resting device 1 among them.

In accordance with an embodiment, said at least one buoyant element 3 is suitable for providing a sufficient buoyancy to keep said at least one tie rod 4 under tension when at least one portion of said linear structure 2 is rested on said resting device 1 and/or when at least one portion of said linear structure 2 is crossed by a passing flow and is rested on said resting device 1.

In accordance with an embodiment, said at least one buoyant element 3 is suitable for providing a sufficient buoyancy to keep said at least one tie rod 4 under tension when said linear structure 2 is crossed by a passing flow and is rested on said resting device 1.

In accordance with an embodiment, said at least one buoyant element 3 has a compact shape, for example it is a buoy or a beacon, and is connected to said resting device 1 so as to provide said resting device 1 with a localized upward thrust.

In accordance with an embodiment, said buoyant element 3 has an elongated shape and is oriented substantially along the longitudinal direction X-X and is connected to at least one portion of said resting device 1, for example a lateral portion 24 thereof, and/or a lower portion 25 thereof, and/or in a base portion 26 thereof so as to provide a distributed upward thrust along said at least one portion of said resting device 1.

In accordance with an embodiment, said at least one buoyant element 3 is made by assembling modules that are fixed to a connection element 16, for example a beam or a tubular element suitable for being connected to said resting device 1, or for being comprised in a portion of said resting device 1, through a fastening system 20, for example comprising hooks, straps and/or clamps.

In accordance with an embodiment, said device 1 comprises a plurality of buoyant elements 3. In accordance with an embodiment, said plurality of buoyant elements 3 comprises various types of floats.

In accordance with an embodiment, said at least one buoyant element 3 is made at least partially from polymeric material, for example resin, suitable for applications in medium depth or deep beds.

In accordance with an embodiment, a removable ballast 15 is connected to said buoyant element 3 and/or to said resting device 1 comprising said buoyant element 3, said removable ballast 15 is suitable for at least partially counteracting the upward thrust provided by said buoyant element 3 so as to promote the immersion of said resting device 1 comprising said buoyant element 3 during the steps of mounting and installing the resting device 1.

In accordance with an embodiment, said at least one removable ballast 15 comprises at least one removable chain able to be connected to said buoyant element 3. In accordance with an embodiment, said at least one removable ballast 15 comprises at least one weight able to be connected to said buoyant element 3 through fastening means such as hooks or screw connections, or through other fastening systems.

In accordance with an embodiment, said at least one tie rod 4 is suitable for working under traction and is substantially unsuitable for working under compression, so as to allow said resting device 1 to make at least heave, pitch and roll movements. In accordance with an embodiment, said resting device 1 forms a yielding support suitable for resting at least one portion of said linear structure 2.

The provision of a yielding support allows said resting device 1 to dampen impulsive and/or transient loads acting on said deck 6 through a movement thereof, for example a heave, pitch and/or roll movement, and then the upward thrust provided by said at least one buoyant element 3 takes said at least one tie rod 4 back under tension.

In accordance with an embodiment, said resting device 1 comprises at least two parapets 7 that extend primarily along the longitudinal direction X-X constrained to said deck 6, so as to form a resting seat 8 with said deck 6 for receiving under conditions of stable equilibrium at least one portion of said linear structure 2 resting on said deck 6. In other words, said resting seat 8 is suitable for forming a bed or a cradle for at least one portion of said linear structure 2.

The provision of a resting seat 8 comprising at least two parapets 7 makes it possible to limit the movement of said portion of linear structure 2 resting on said deck 6 preventing it from accidentally coming out.

In accordance with an embodiment, said at least two parapets 7 have a shape suitable for guiding at least one portion of said linear structure 2 in said resting seat 8, so as to take at least one portion of said linear structure 2 into a position substantially centered on said deck 6 of said resting device 1 and keep it there.

In accordance with an embodiment, when said device 1 is seen in a cross section thereof, i.e. a section thereof perpendicular to the longitudinal direction X-X, said resting seat 8 describes a substantial V shape. In accordance with an embodiment, when said device 1 is seen in a cross section thereof, said resting seat 8 describes a substantial U shape.

The provision of at least one tie rod 4 unsuitable for working under compression, as well as parapets 7 makes said resting device 1 suitable for resting gently and at the same time securely for at least one portion of said linear structure 2.

Keeping at least one portion of said linear structure 2 in a position substantially centered on said deck 6 of said resting device 1 makes it possible to evenly distribute the forces acting on said resting device 1, and, if a plurality of tie rods 4 is foreseen, to balance the tension forces acting on each tie rod 4 of said plurality of tie rods 4, as well as making it possible to prevent accidental flipping of said deck 6 that could lead to said linear structure 2 falling on bed 5 close to or at an uneven underwater topography.

In accordance with an embodiment, said resting device 1 comprises at least one truss 9.

In accordance with an embodiment, said deck 6 comprises a truss 9 that comprises a plurality of cross beams 11, and wherein said plurality of cross beams 11 is suitable for allowing distributed resting of at least one portion of said linear structure 2. In this way, even if each cross beam 11 is suitable for allowing precise resting of the linear structure 2, said plurality of cross beams 11 is suitable for allowing distributed resting of the linear structure 2.

In accordance with an embodiment, each cross beam 11 of said plurality of cross beams 11 extends in a transversal direction to the longitudinal direction X-X. In accordance with an embodiment, each cross beam 11 of said plurality of cross beams 11 extends in a transversal direction to the longitudinal deck direction Y-Y.

In accordance with an embodiment, said cross beams 11 of said plurality of cross beams are spaced apart by a predetermined distance along the longitudinal direction X-X. In this way, said deck 6 is suitable for allowing the linear structure 2 to form a plurality of suspended sections, or sections not supported by said cross beams 11. Such a predetermined distance is selected so as to avoid jamming of the linear structure 2, peaks of tension and of localized deformations on portions of said linear structure 2, by the effect of the weight of the linear structure 2 itself.

Making at least one truss makes it possible to reduce the weight of the device 1 as well as to reduce the viscous friction coefficient of said resting device 1, improving the fluid-dynamic compatibility thereof with underwater currents and marine weather phenomena.

In accordance with an embodiment, said truss 9 comprises a plurality of cross support beams 36, arranged below said plurality of cross beams 11 forming said deck 6. Said support cross beams 36 perform a structural reinforcement function.

In accordance with an embodiment, said plurality of support cross beams 36 form a rigidifying structure of said resting device 1.

In accordance with an embodiment, said plurality of reinforcing cross beams 36 are parallel to said plurality of cross beams 11. In accordance with an embodiment, said plurality of reinforcing cross beams 36 and said plurality of cross beams 11 follow arched paths along the longitudinal deck direction Y-Y that are parallel to each other.

In accordance with an embodiment, said truss 9 is arranged like an arc, avoiding comprising a straight beam that connects together the two shoulder portions 19 of said resting device 1.

In accordance with an embodiment, the structure of the resting device 1, or bridge, has a longitudinal extension of substantial size.

In accordance with an embodiment, the resting device 1 has a lower structural portion 37 comprising said support cross beams 36 and an upper structural portion 38 comprising said deck 6 that allows the linear structure 2 to be rested, even discretely. In accordance with an embodiment, said lower structural portion 37 and said upper structural portion 38 coincide.

In accordance with an embodiment, said lower structural portion 37 and said upper structural portion 38 follow said longitudinal deck direction Y-Y forming a rigid and arched structure, preventing that, due to the substantial longitudinal extension of the resting device 1, there are rectilinear elements that connect together said two longitudinally opposite shoulder portions 19. In other words, the lower structural portion 37 forms an arched structure in the longitudinal deck direction Y-Y. In other words, said lower structural portion 37 extends along said longitudinal deck direction Y-Y.

In accordance with an embodiment, said at least one buoyant element 3 is of a shape and size such as to be arranged in at least one portion of the space between the elements of said truss 9. The arrangement of said at least one buoyant element 3 in at least one portion of the space between the elements of said linear truss 9 makes it possible to make a resting device 1 with a compact shape, further improving the fluid-dynamic properties and the interaction with the underwater environment.

In accordance with an embodiment, each buoyant element 3 extends for a longitudinal dimension shorter than one third of the longitudinal extension of the resting device 1. Preferably, each buoyant element 3 has an extension substantially equal to the distance between two successive cross beams 11 constituting said deck 6.

In accordance with an embodiment, said deck 6 comprises an elastomeric mat suitable for forming a distributed rest for at least one portion of said linear structure 2. In accordance with an embodiment, said deck 6 comprises at least one sheet of polyurethane suitable for forming a distributed rest for at least one portion of said linear structure 2.

In accordance with an embodiment, said deck 6 comprises a plurality of rollers, suitable for forming a distributed rest for at least one portion of linear structure 2. The provision of a deck 6 comprising rollers makes it possible to minimize the sliding friction between said linear structure 2 and said deck 6, allowing relative alignment movements in laying or operating conditions.

In accordance with an embodiment, said deck 6 is made of metallic material, like for example steel or quenched steel. In accordance with an embodiment, said resting device 1 is at least primarily made of metallic material like for example steel or quenched steel. In accordance with an embodiment said deck 6 comprises at least one portion made of polymeric material, like for example and not for limiting purposes nylon, elastomer or polyurethane.

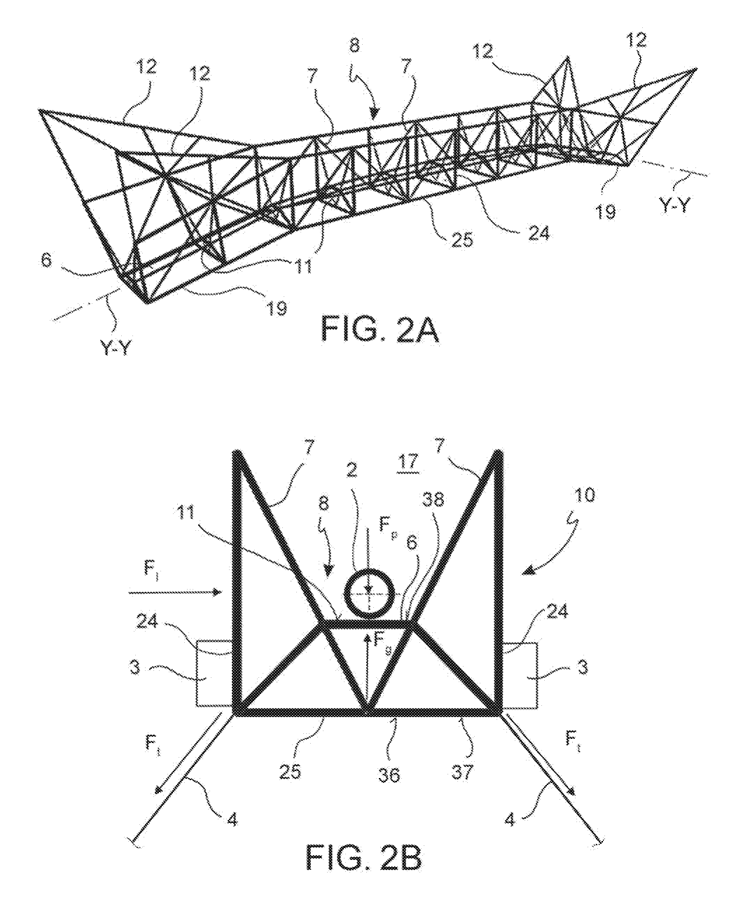

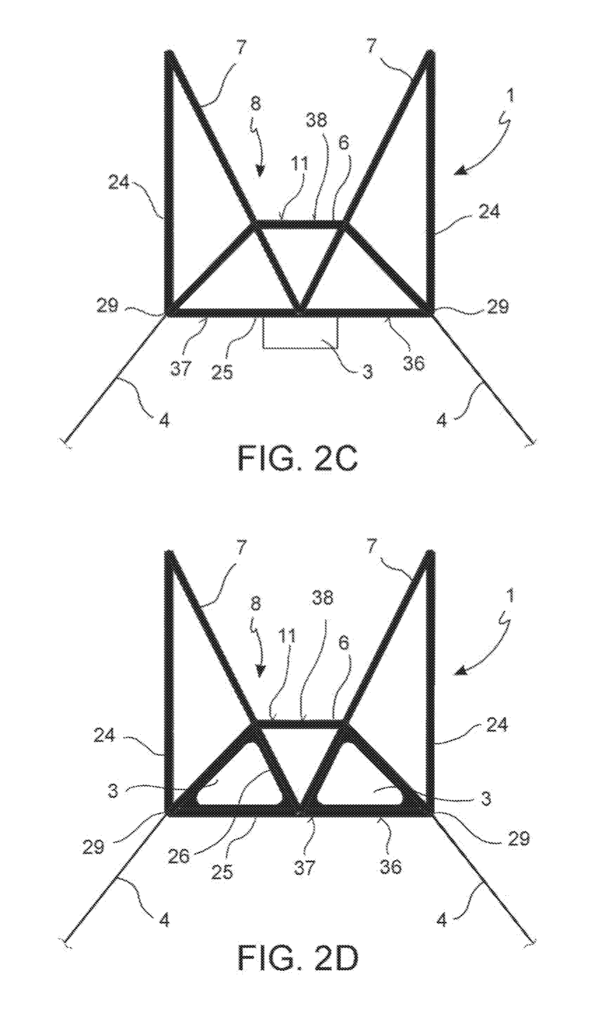

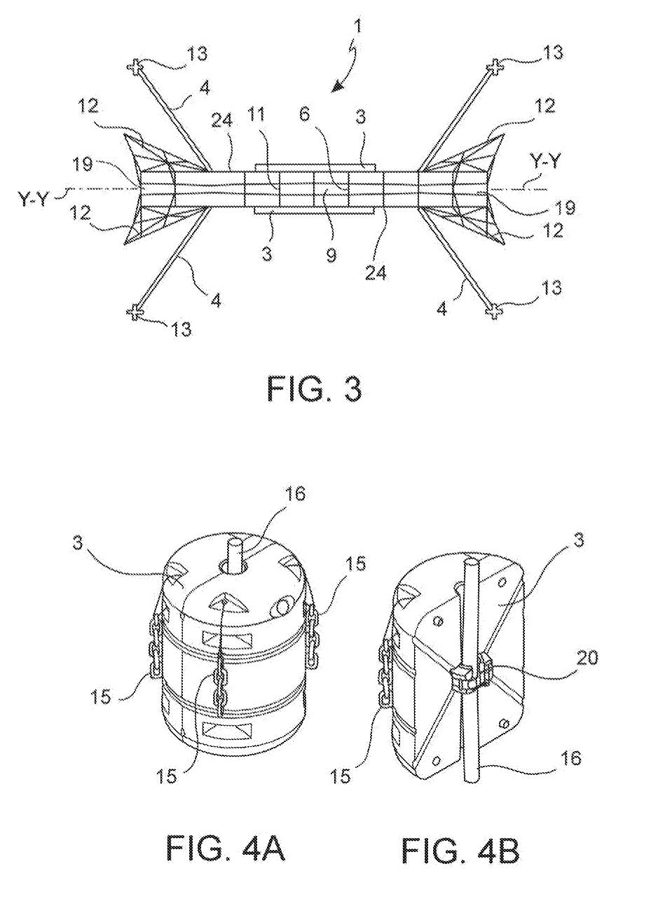

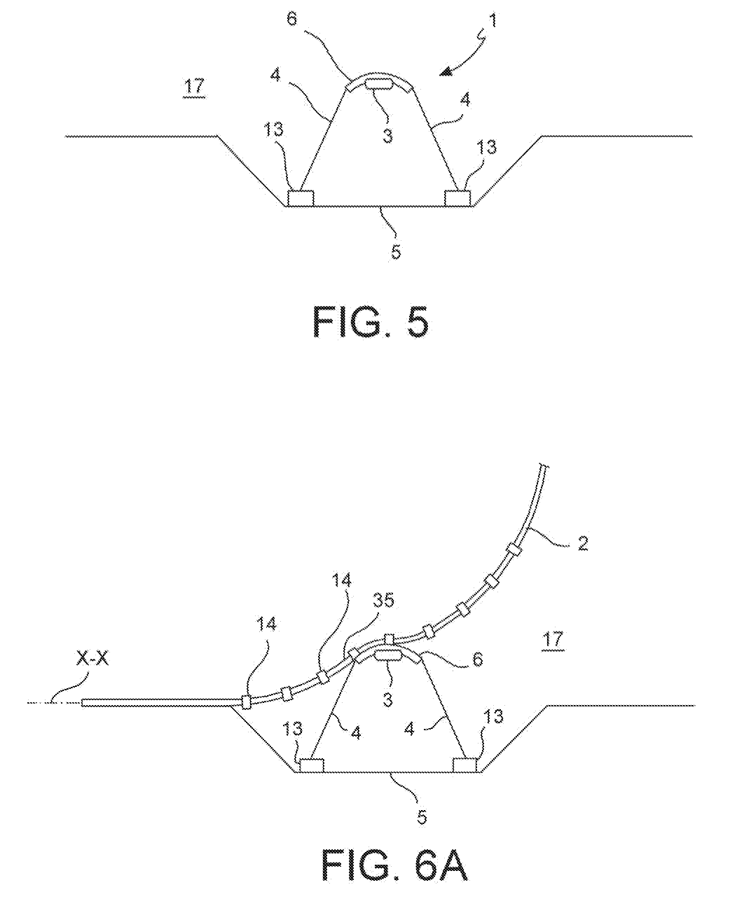

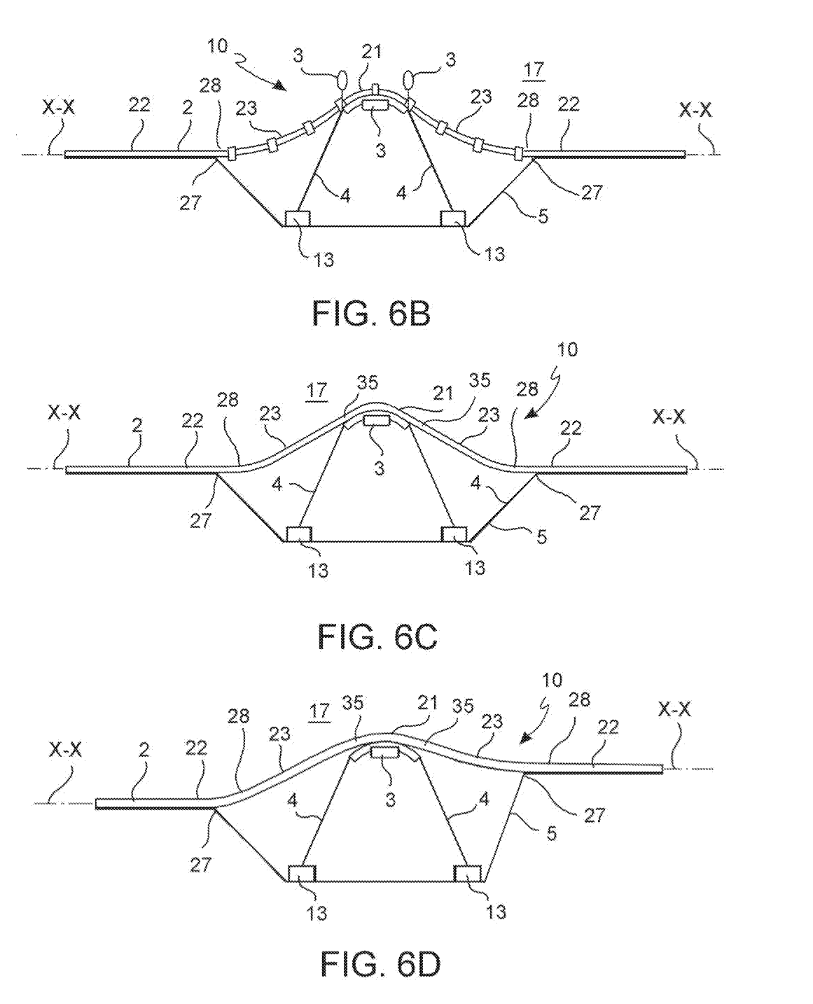

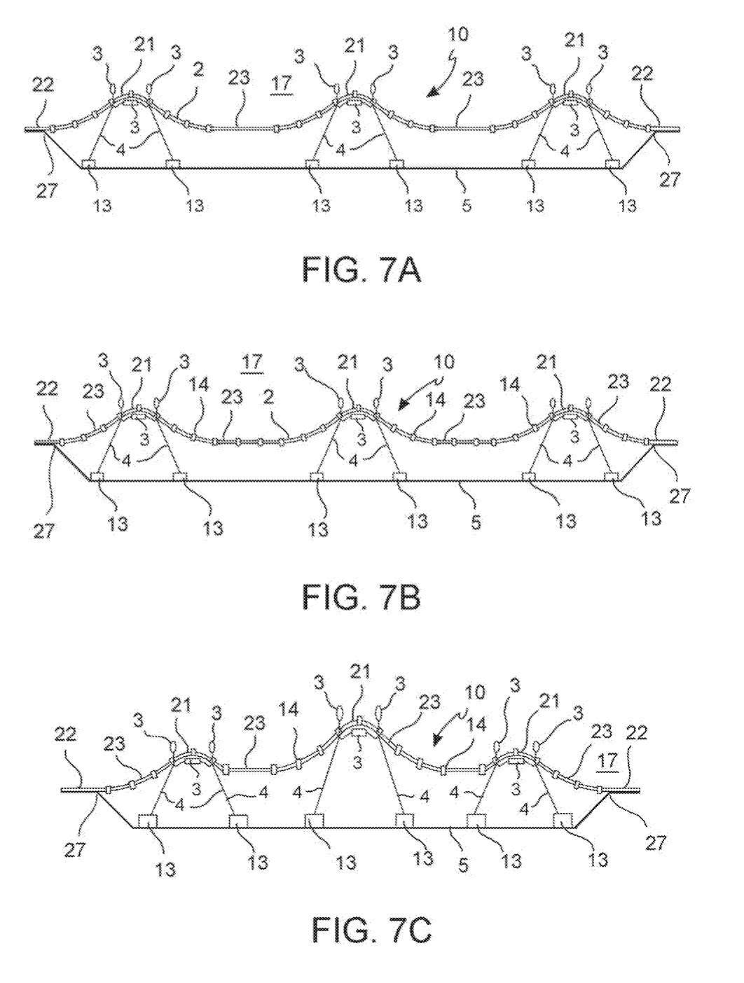

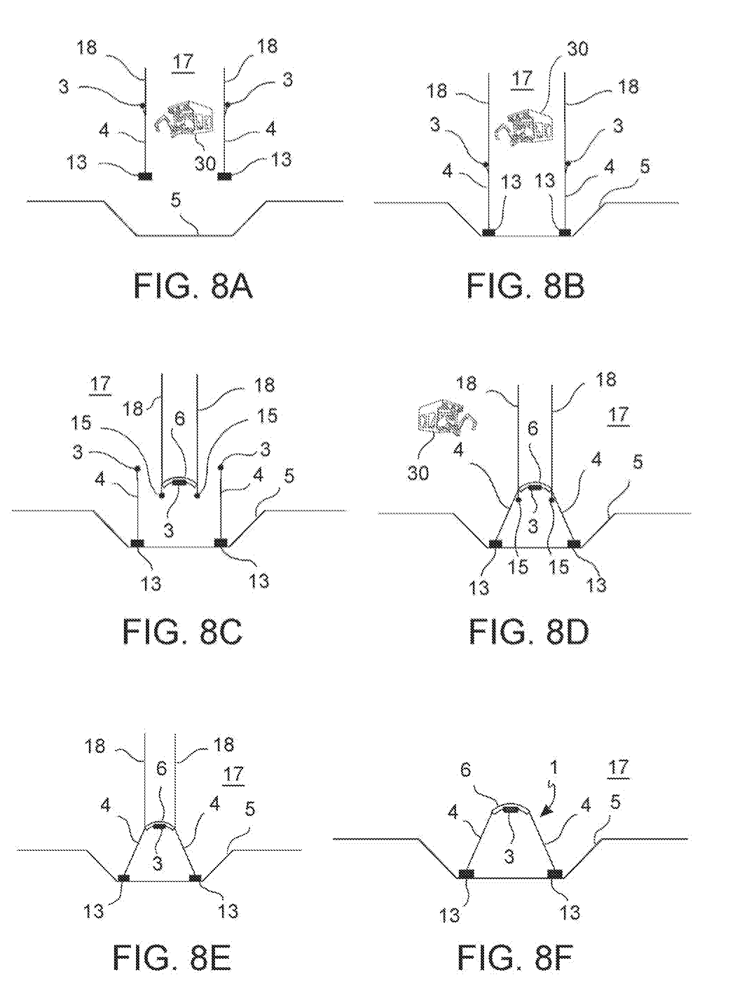

As shown for example in FIGS. 2B, 2C o 2D, said resting device 1 has a transversal section to the longitudinal deck direction Y-Y.

In accordance with an embodiment, in each cross section, the distance between said cross beam 11 of said deck 6 and said support cross beam 36 is constant.

In accordance with an embodiment, two opposite tie rods 4 in the cross section extend diverging, or moving apart, from one another, moving from the resting device 1 towards the anchoring elements 13 to the bed. In accordance with an embodiment, two opposite tie rods 4 extend diverging, or moving apart, from one another, moving from the resting device 1 towards the anchoring elements 13 to the bed. In accordance with an embodiment, said resting device 1 comprises at least two guiding wings 12 that extend diverging with respect to said deck 6, and wherein said guiding wings 12 are suitable for guiding at least one portion of said linear structure 2 in said resting seat 8.

In accordance with an embodiment, said at least two guiding wings 12 are an extension of said at least two parapets 7 and are arranged in said shoulder portions 19 of said resting device 1 and/or close to corner portions 29 of said resting device 1.

The provision of said at least two guiding wings 12 makes it possible to simplify the laying operation of at least one portion of said linear structure 2 on said deck 6 of said resting device 1.

In accordance with a general embodiment, an assembly 10 comprises at least one resting device 1 as described in any one of the embodiments and said linear structure 2 mentioned above. Said linear structure 2 comprises at least one first section 21, rested in a distributed manner on said deck 6 of said resting device 1, at least one second section 22, laid on a portion of said bed 5, and at least one third section 23, suspended and interposed between said first section 21 and said second section 22. In accordance with an embodiment, said linear structure 2 is suitable for providing a passing flow inside it. In accordance with an embodiment, said resting device 1 comprises at least one buoyant element 3. In accordance with an embodiment, said at least one buoyant element 3 is suitable for keeping said at least one tie rod 4 taut when said at least one first section 21 is rested on said deck 6 of said resting device 1.

In accordance with an embodiment, said at least one first section 21 is rested in a distributed manner on said deck 6 of said resting device 1, i.e. so that not necessarily a single continuous portion, namely a portion delimited by a single closed perimeter, of said first section 21 is in contact with said deck 6. In other words, said first section 21 can rest on said deck 6 in a plurality of distinct portions thereof and distributed along the longitudinal direction X-X.

Said bed 5 can also comprise a knee 27, i.e. an area characterized by a sudden change in slope.

In accordance with an embodiment, said at least one third section 23 comprises at least one detachment portion 28, wherein said at least one detachment portion 28 is adjacent to said at least one second section 22, and wherein said detachment portion 28 is suitable for being at or close to said knee 27 of the bed.

In accordance with an embodiment, said at least one detachment portion 28 is suitable for being oriented along a substantially horizontal direction. In other words, the longitudinal direction X-X of said linear structure 2 is substantially parallel to the horizontal plane, i.e. the plane perpendicular to the direction of the force of gravity, at least in said detachment portion 28.

In accordance with an embodiment, said resting device 1 comprises said at least one tie rod 4 sized so as to allow said at least one detachment portion 28 to be oriented along a substantially horizontal direction or to take said third section 23 and first section 21 to form a concavity that, in crossing a bed height difference, for example a canyon, forms concavities of large radius that do not cause localized overstress in the linear structure.

In accordance with an embodiment, said at least one first section 21 comprises at least two detachment portions of first section 35, adjacent to said third section 23 and suitable for resting on said shoulder portions 19 of said deck 6, wherein said detachment portions of first section 35 are suitable for being arranged horizontally or vertically.

In accordance with an embodiment, said shoulder portions are inclined so as to avoid being arranged horizontally or vertically. In this way, the portions of linear structure 2 rested on said shoulder portions 19 avoid being arranged horizontally or vertically.

By avoiding detaching from said deck when oriented horizontally, said linear structure 2 is suitable for passing the maximum longitudinal distance of said uneven underwater topography for the same length and height of the resting device 1, without for this reason forcing said third section 23 to form a catenary shaped suspended portion.

In accordance with an embodiment, said first section 21 of linear structure has a wide radius of curvature. By avoiding having a narrow radius of curvature, said first section 21 avoids forming jamming points having stress peaks.

In accordance with an embodiment, said linear structure 2 comprises at least one buoyant system suitable for providing an up-thrust sufficient to at least partially counter the weight of said at least one first section 21, of said at least one third section 23 and of said flow passing inside said at least one first section 21 and said at least one third section 23.

In accordance with an embodiment, said at least one buoyant system comprises a plurality of floats 14 distributed along at least one portion of said linear structure 2.

In accordance with an embodiment, said plurality of floats 14 distributed along at least one portion of said linear structure 2 cooperates with said at least one buoyant element 3 of said resting device 1 to provide an up-thrust sufficient to keep said at least one tie rod 4 under tension under the weight of said assembly 10 and of said passing flow.

The spreading of the up-thrust among said at least one buoyant element 3 and said plurality of distributed floats 14 makes it possible to prevent, in the condition of an unloaded resting device 1, i.e. not carrying the weight of any portion of said linear structure 2, possible jerking of said at least one tie rod 4, wherein said jerking could extract the anchors from the bed 5 and/or tear said at least one tie rod 4, and at the same time allows said at least one tie rod 4 to be kept under tension even in a condition with the resting device 1 unloaded.

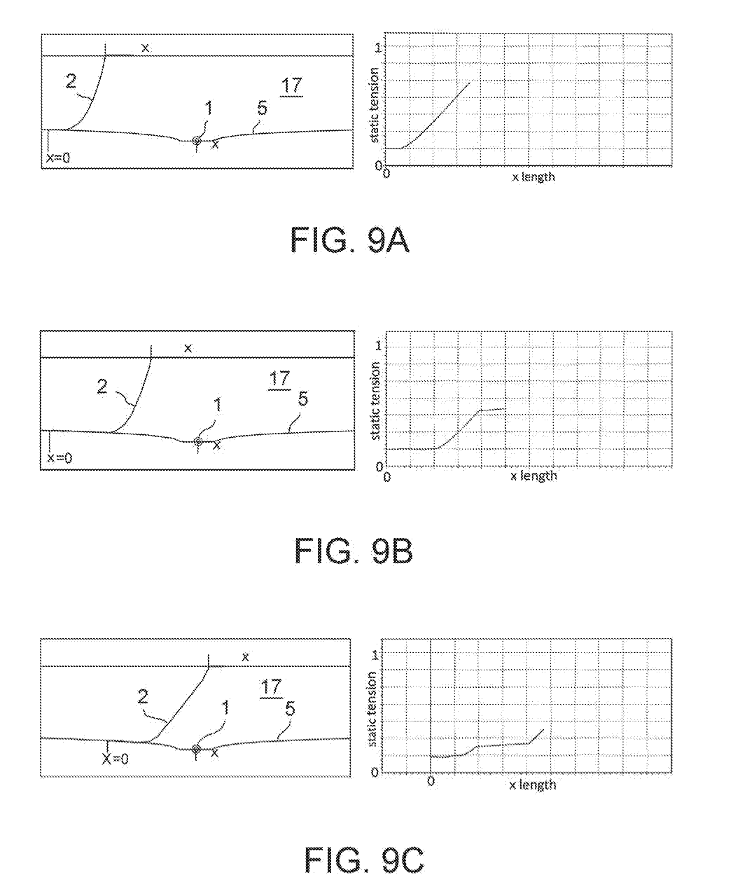

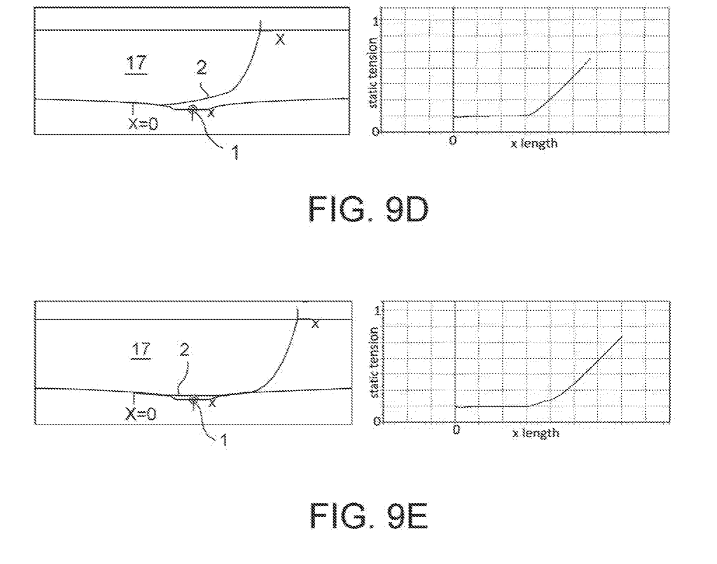

As shown in FIGS. 9B and 9C, the provision of a plurality of floats 14 distributed along at least one portion of said linear structure 2 makes it possible to reduce the static longitudinal tensions acting on said linear structure 2 during the laying of said linear structure 2.

FIG. 2B illustrates a diagram of the forces acting on a schematized section of an assembly 10 in accordance with an embodiment of the invention, wherein:
Fₚ indicates the net weight of at least one portion of said linear structure 2, i.e. the weight of said at least one first section 21, of said third section 23 and of said passing flow decreased by the up-thrust provided by said plurality of floats 14,
F_{g} indicates the up-thrust provided by the resting device 1,
Fₗ indicates the lateral force, comprising the force generated by the underwater currents or by marine weather forcers;
Fₜ indicates the tension of tie rod.

In accordance with an embodiment, said plurality of floats 14 distributed along at least one portion of said linear structure 2 comprises permanent floats, or unsuitable for being removed in operative conditions.

In accordance with an embodiment, said plurality of floats 14 distributed along at least one portion of said linear structure 2 comprises floats suitable for being sized so as to provide at least one portion of said linear structure 2 with properties of differentiated floating, or differentiated lightening, for example by acting on the distance between adjacent floats or by acting on the volume of the air chamber of at least one float of said plurality of floats 14.

By acting on the sizing of the floating properties of said resting device 1 and of said linear structure 2 and on the sizing of said at least one tie rod 4, it is possible to adjust the height difference between the bed 5 at said knee 27 and said resting device 1, for example so as to give said linear structure a substantially horizontal extension, or with concavity having gentle or gradual variation, particularly in detachment portions 28 thereof.

By acting on the sizing of the floating properties of said resting device 1 and of said linear structure 2, it is possible to give said linear structure 2 an optimized geometry to avoid concentration of stresses and of tensions as well as phenomena of structural instability (buckling) along the longitudinal direction X-X.

With reference to the figures and to the previous description, hereinafter a resting method of at least one portion of linear structure 2 for crossing an uneven underwater topography will be described.

A resting method of at least one portion of linear structure 2 for crossing an uneven underwater topography, comprises the following steps, listed according to a preferred, but not necessary temporal order:
providing at least one resting device 1 as described above in any one of the embodiments;
resting at least one portion of said linear structure 2 on said at least one resting device 1.

According to a possible way of operating, a resting method comprises at least one of the following further steps, listed according to a preferred, but not necessary temporal order:
identifying a bed 5 that comprises an uneven underwater topography;
connecting at least one tie rod 4 to at least one disconnectable installation line 18;
connecting at least one buoyant element 3 to said at least one tie rod 4;
lowering said at least one tie rod 4 into a mass of water 17, at or close to said uneven underwater topography;
anchoring said at least one tie rod 4 of said resting device 1 to said bed 5 through said at least one anchoring element 13;
disconnecting said at least one tie rod 4 from said at least one disconnectable installation line 18;
connecting said at least one removable ballast 15 to said at least one resting device 1;
connecting said at least one resting device 1 to at least one disconnectable installation line 18;
lowering said at least one resting device 1 into said mass of water 17 at said uneven underwater topography of said bed 5;
connecting said at least one resting device 1 to said at least one tie rod 4 anchored to said bed 5;
disconnecting at least one removable ballast 15 from said at least one resting device 1;
disconnecting said at least one buoyant element 3 from said tie rod 4 anchored to said bed 5;
connecting said plurality of distributed floats 14 to at least one portion of said linear structure 2;
lowering said linear structure 2 into said mass of water 17;
laying a second section 22 of said linear structure 2 on said bed 5 close to or at a knee 27 of said bed 5;
keeping said linear structure 2 under tension so that said at least one detachment portion 28 of said linear structure 2 is oriented in a substantially horizontal direction;
resting said at least one first section 21 on said resting device 1;
connecting said at least one buoyant element 3 to said resting device 1;

In accordance with a possible way of operating, the operation of laying said linear structure 2 takes place through the use of a laying device 33 and substantially in accordance with the known J-lay method, schematically illustrated in FIG. 1A, which foresees the use of a laying tower 32, or laying crane 32, suitable for lowering said linear structure 2 in a mass of water 17, giving it the characteristic J shape; in accordance with a possible way of operating, the operation of laying said linear structure 2 takes place through the use of a laying device 33 and substantially in accordance with the known S-lay method, schematically illustrated in FIG. 1B, which foresees the use of a laying ramp 34, giving it the characteristic S shape.

In accordance with a possible way of operating, the use of at least one underwater robot 30, for example a remotely operated underwater vehicle (or “ROV”) 30, or an autonomous underwater vehicle (or “AUV”) 30, makes it possible to carry out at least one of the steps described earlier remotely, or from a remote station. An underwater robot 30 is suitable for operating diving into deep water close to medium or great depth beds and can comprise mechanical arms suitable for operating on said at least one installation line 18 or on a plurality of installation lines 18 simultaneously.

In accordance with a possible way of operating, the use of at least one crane makes it possible to carry out at least one of the steps described earlier. In accordance with a possible way of operating, the use of said at least one crane makes it possible to lower said at least one disconnectable installation line 18 or a plurality of disconnectable installation lines 18 simultaneously into said mass of water 17.

In accordance with a possible way of operating, keeping said linear structure 2 under tension so that said at least one detachment portion 28 of said linear structure 2 is oriented in a substantially horizontal direction makes it possible to prevent said linear structure 2 from following the height difference of the profile of the bed 5 at least close to or at said knee 27, avoiding a deformation of the linear structure 2 and preventing the occurrence of even permanent localized tensions on the linear structure 2 that could cause problems in operative conditions.

In accordance with a possible way of operating, said deck 6 is substantially arc shaped, and wherein said linear structure 2 is rested firstly on a central portion along the longitudinal direction X-X of said deck 6. In this way, the resting of said linear structure 2 on the remaining portions of said arc-shaped deck 6 is optimized.

In accordance with a possible way of operating, at least two disconnectable installation lines 18 are used simultaneously.

In accordance with an embodiment, said at least one disconnectable installation line 18 comprises at least one flexible element, and said flexible element is a chain, or at least one cable, or a plurality of twisted cables, or a metallic cable, or a stranded metallic cable, or a metallic strand, or it is made of textile fibers or polymeric fibers, or it is a combination of the above.

In accordance with an embodiment, said at least one flexible element of said disconnectable installation line 18 is an anti-rotation cable; in accordance with an embodiment said at least one flexible element of said disconnectable installation line 18 comprises at least one sheath, for example a sheath made of zinc or polymeric material, suitable for making said disconnectable installation line 18 anti-rotation.

The use of an anti-rotation element allows improved precision as well as greater control of the installation steps of the resting device 1.

In accordance with an embodiment, said disconnectable installation line 18 comprises at least one removable ballast 15, suitable for keeping said disconnectable installation line 18 substantially under tension when it is immersed in said mass of water 17.

In accordance with a possible way of operating, said at least one tie rod 4 is connected to at least one buoyant element 3 so as to keep said tie rod 4 under tension, during the installation step of said resting device 1.

For example, said uneven underwater topography extends for about 2 kilometers, and said deck extends for about 50 meters, and said tie rods 4 carry said deck 6 of said resting device 1 about 200 meters away from the bed.

Those skilled in the art can makes numerous modifications, adaptations and replacement of elements with other functionally equivalent ones to the embodiments described above, in order to satisfy contingent and specific requirements, without however departing from the scope of the following claims.

### REFERENCE LIST

1. Resting device
2. Linear structure
3. Buoyant element of resting device
4. Tie rod
5. Bed
6. Deck
7. Parapet
8. Resting seat
9. Truss
10. Assembly
11. Cross beams
12. Guiding wings
13. Anchoring element
14. Floats distributed along linear structure
15. Removable ballast
16. Float connection elements
17. Mass of water
18. Disconnectable installation line
19. Shoulder portion of resting device
20. Fastening system
21. First section of linear structure, or resting section
22. Second section of linear structure, or laid section
23. Third section of linear structure, or suspended section
24. Side portion of resting device
25. Lower portion of resting device
26. Base of device
27. Knee of the bed
28. Detachment point of said linear structure
29. Corner portion of resting device
30. Underwater robot
32. Laying crane, or laying tower
33. Laying device
34. Laying ramp
35. Detachment portion of first section
36. Support cross beam
37. Lower structural portion
38. Upper structural portion
Ft. Tie rod force, or tie rod tension
Fp. Net weight force of linear structure
Fg. Up-thrust of resting device
Fl. Lateral force
X-X. Longitudinal direction, or direction of extension of the linear structure
Y-Y. Longitudinal deck direction

1.-10. (canceled)

11. A resting device of at least one portion of a linear structure for crossing an uneven underwater topography, wherein said resting device is suitable for supporting at least one portion of said linear structure that defines a longitudinal direction coincident with or parallel to the longitudinal development direction of said linear structure;
said resting device comprising:
at least one buoyant element;
at least one tie rod, suitable for constraining said resting device to a bed of a body of water, wherein said at least one buoyant element is suitable for providing an up-thrust sufficient to maintain said at least one tie rod in tension;
a deck of shape and material allowing distributed rest of at least one portion of said linear structure on said resting device.

12. The resting device according to claim 11, wherein each buoyant element extends for a longitudinal dimension shorter than one third of the longitudinal extension of the resting device; and/or wherein said resting device is a rigid bridge; and/or
wherein said resting device avoids comprising joints or articulations suitable for allowing relative movement of portions of said deck; and/or
wherein said deck has a longitudinal extension between 25 meters and 100 meters; and/or
wherein a longitudinal deck direction is defined, substantially coincident with the longitudinal development direction of said deck; and/or
wherein said longitudinal deck direction is coincident with or parallel to the longitudinal direction of said linear structure; and/or
wherein said deck describes a height difference at least along the longitudinal direction suitable for allowing distributed rest of at least one portion of said linear structure; and/or
wherein said deck describes a substantial arc shape along the longitudinal direction; and/or
wherein said device comprises at least one further tie rod, so as to comprise at least two tie rods, and wherein said at least two tie rods are anchored or resting on said bed by means of anchoring means; and/or
wherein said at least two tie rods are constrained to said resting device in shoulder portions thereof; and/or
wherein said tie rods are at least four tie rods and are constrained in proximity to four corner portions to said resting device.

13. The resting device according to claim 11, wherein said at least one buoyant element is suitable for providing a buoyancy sufficient to maintain said at least one tie rod in tension when at least one portion of said linear structure rests on said resting device and/or when a flow passes through at least one portion of said linear structure and the linear structure rests on said resting device.

14. The resting device according to claim 11, wherein said at least one tie rod is suitable for working under traction and is substantially unsuitable for working under compression, to allow at least heave, pitch and roll motions of said resting device.

15. The resting device according to claim 11, wherein said resting device comprises at least two parapets that extend substantially along the longitudinal direction constrained to said deck, so as to form a resting seat with said deck to receive under conditions of stable equilibrium at least one portion of said linear structure resting on said deck; and/or
wherein said deck comprises a truss that comprises a plurality of cross beams, and wherein said plurality of cross beams is suitable for allowing a distributed rest of at least one portion of said linear structure; and/or
wherein said resting device comprises at least two guiding wings that extend diverging from said deck, and wherein said guiding wings are suitable for guiding at least one portion of said linear structure in said resting seat during laying of said linear structure.

16. An assembly comprising at least one resting device according to claim 11 and said linear structure, wherein said linear structure comprises:
at least one first section, resting on said deck of said resting device;
at least one second section, placed on a portion of said bed;
at least one third section, suspended and interposed between said first section and said second section;
and wherein said linear structure is suitable for providing a passing flow therein;
and wherein said resting device comprises at least one buoyant element;
and wherein said at least one buoyant element is suitable for maintaining said at least one tie rod in tension when said at least one first section is supported on said deck of said resting device.

17. The assembly according to claim 16, wherein said linear structure comprises at least one buoyant system suitable for providing an up-thrust sufficient to at least partially counter the weight of:
said at least one first section;
said at least one third section;
said flow passing inside said at least one first section and inside said at least one third section.

18. Assembly according to claim 16, wherein said at least one buoyant system comprises a plurality of floats distributed along at least one portion of said linear structure.

19. A method for resting at least one portion of linear structure for crossing an uneven underwater topography, comprising the following steps:
providing at least one resting device according to claim 11;
resting at least one portion of said linear structure on said at least one resting device.

20. The method according to claim 19, comprising at least one of the following further steps:
locating a bed that comprises an uneven underwater topography; and/or
connecting at least one tie rod to at least one disconnectable installation line; and/or
lowering said at least one tie rod in a mass of water, at or in proximity to said uneven underwater topography; and/or
anchoring said at least one tie rod of said resting device to said bed by said at least one anchoring element; and/or
disconnecting said at least one tie rod from said at least one disconnectable installation line; and/or
connecting at least one buoyant element to said at least one tie rod; and/or
connecting at least one removable ballast to said at least one resting device; and/or
connecting said at least one resting device to at least one disconnectable installation line; and/or
lowering said at least one resting device in said mass of water at said uneven underwater topography of said bed; and/or
connecting said at least one resting device to said at least one tie rod anchored to said bed; and/or
disconnecting at least one removable ballast from said at least one resting device; and/or
disconnecting said at least one buoyant element from said tie rod anchored to said bed; and/or
connecting said plurality of distributed floats to at least one portion of said linear structure; and/or
lowering said linear structure in said mass of water; and/or
placing a second section of said linear structure on said bed in proximity to or at a knee of said bed; and/or
maintaining said linear structure under tension such that said at least one detachment portion of said linear structure is oriented in a substantially horizontal direction; and/or
resting said at least one first section on said resting device; and/or
connecting said at least one buoyant element to said resting device.
